(19) United States
(12) Patent Application Publication
(10) Pub. No.: US 2006/0280577 A1
(43) Pub. Date: Dec. 14, 2006

(54) Multiple shank nail

(76) Inventor: Peter Iliev, Birmingham, AL (US)

Correspondence Address: LITMAN LAW OFFICES, LTD, PO BOX 15035, CRYSTAL CITY STATION, ARLINGTON, VA, 22215, US

(21) Appl. No.: 11/444,313

(22) Filed: Jun. 1, 2006

Related U.S. Application Data
(60) Provisional application No. 60/688,375, filed on Jun. 8, 2005.

(51) Int. Cl. F16B 15/00

(52) U.S. Cl. 411/471

(57) ABSTRACT

The multiple shank nail includes a head and two or more shanks. The head has a top and bottom surface and each shank extends longitudinally from the bottom surface of the head and terminates in a point, the point being capable of piercing a substance into which the nail is to be secured. The two or more shanks of the nail are separated by one or more slots that extend from a solid portion along the bottom surface of the head through the points of each of the shanks. The separated shanks are spread apart from one another as the nail is driven into a surface by its head, providing extra support and hold with the use of a single nail.

### CROSS-REFERENCE TO RELATED APPLICATION

This application claims the benefit of U.S. Provisional Patent Application Ser. No. 60/688,375, filed Jun. 8, 2005.

### BACKGROUND OF THE INVENTION

1. Field of the Invention

The present invention relates to fasteners, and more specifically to a nail with multiple shanks.

2. Description of the Related Art

Standard, single shank nails are commonly used throughout the building and carpentry industries as fasteners for materials of all sorts. However, nails with a single shank are not always convenient in certain circumstances.

With an ordinary, single shank nail, it is often difficult to penetrate a surface that has another nail head or nail stub directly below it because the nail will strike the pre-existing head or stub and be damaged. Likewise, when trying to drive a single shank nail in at an angle, the user is often forced to swing the hammer at an odd angle, increasing the likelihood of injury and decreasing the overall hold of the nail itself.

What is needed is a nail with two or more shanks that provides added hold and stability with the ease of having to drive only a single nail head. It is desirable that the multiple shanks spread apart from one another as the nail is driven into a surface, providing added hold and coverage of the nail within the desired surface. Thus a multiple shank nail solving the aforementioned problems is desired.

### SUMMARY OF THE INVENTION

The multiple shank nail of the present invention includes a head and two or more shanks. The head has a top and bottom surface and each shank extends longitudinally from the bottom surface of the head and terminates in a point, the point being capable of piercing a substance into which the nail is to be secured. The two or more shanks of the nail are separated by one or more slots that extend from a solid portion along the bottom surface of the head through the points of each of the shanks. The separated shanks are spread apart from one another as the nail is driven into a surface by its head, thus providing extra support and hold with the use of a single nail.

The points on each of the shanks are tapered points and the taper can be manipulated such that the shanks can be driven into a surface at varying angles, depending on the need of the fastener. For additional hold and support, each shank may be provided with upwardly facing barbs that help the shank maintain its position once it has been secured into the desired surface.

These and other features of the present invention will become readily apparent upon further review of the following specification and drawings.

### BRIEF DESCRIPTION OF THE DRAWINGS

FIG. 1 is a perspective view of a preferred embodiment of a multiple shank nail according to the present invention.

FIG. 2 is a front view of a preferred embodiment of a multiple shank nail according to the present invention.

FIG. 3 is a perspective view of a preferred embodiment of a multiple shank nail according to the present invention.

FIG. 3A is an enlarged partial view of a preferred embodiment of a multiple shank nail according to the present invention.

FIG. 4 is a partial front view of a preferred embodiment of a multiple shank nail with a first alternate shank configuration according to the present invention.

FIG. 5 is a partial front view of a preferred embodiment of a multiple shank nail with a second alternate shank configuration according to the present invention.

FIG. 6 is a perspective view of a first alternate embodiment of a multiple shank nail according to the present invention.

FIG. 7 is a perspective view of a second alternate embodiment of a multiple shank nail according to the present invention.

FIG. 8 is a front view of a third alternate embodiment of a multiple shank nail according to the present invention.

FIG. 9 is a front view of a fourth alternate embodiment of a multiple shank nail according to the present invention.

Similar reference characters denote corresponding features consistently throughout the attached drawings.

### DETAILED DESCRIPTION OF THE PREFERRED EMBODIMENTS

The present invention is a multiple shank nail, of which a preferred embodiment is shown generally as 10 in the drawings.

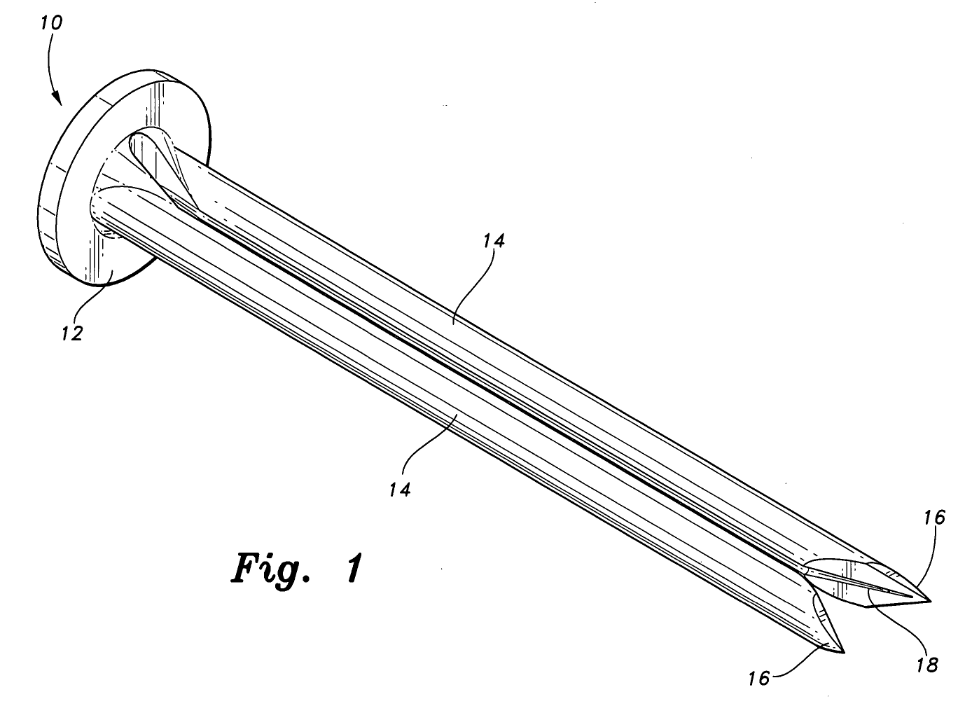

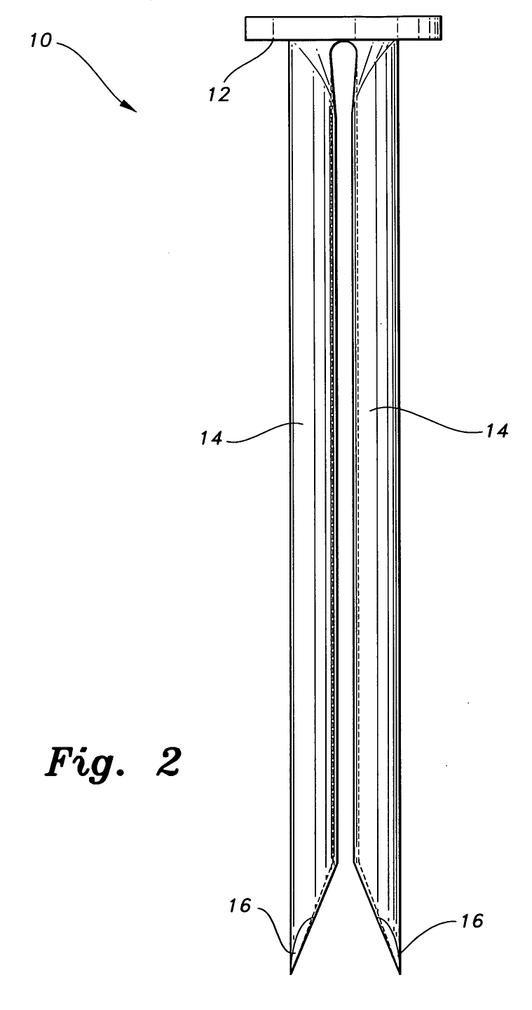

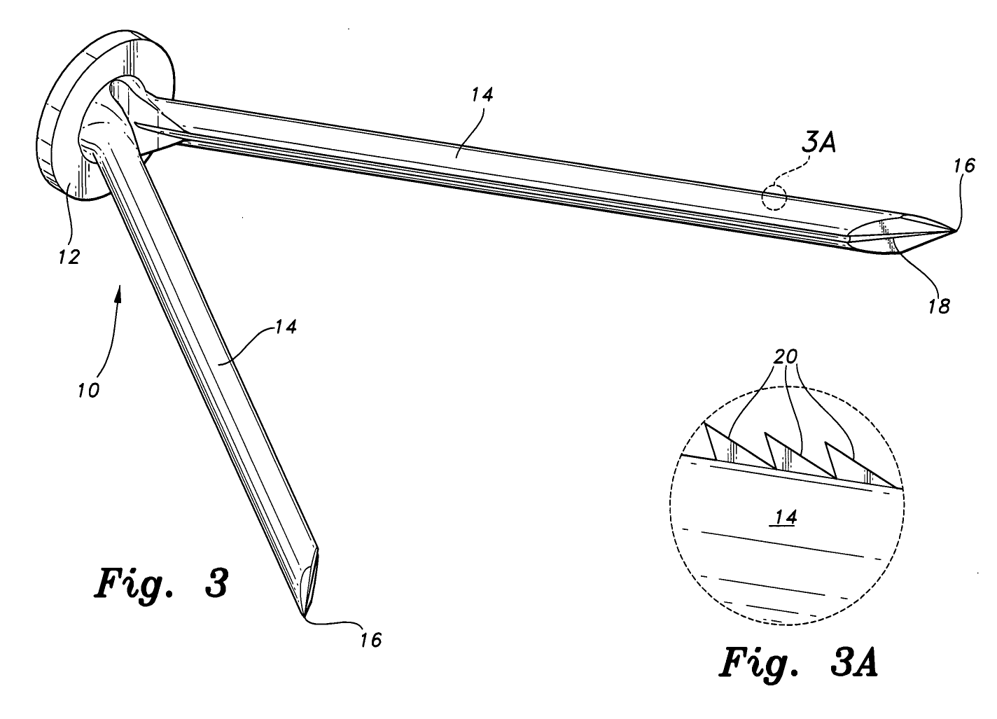

Referring to FIGS. 1-3, multiple shank nail 10 has a head 12 and two shanks 14. Each shank 14 extends longitudinally from the bottom surface of head 12 and terminates in a pointed end 16. The two shanks 14 are separated by a slot extending from a solid portion along the bottom surface of the head 12 through the pointed end 16 of each of the two shanks 14. Each pointed end 16 of each shank 14 has a tapered configuration such that the two shanks 14 are split apart as the multiple shank nail 10 is driven into a surface by the head 12. The taper of each pointed end 16 can be manipulated such that the shanks 14 will be split at varying angles as they are driven into a desired surface. To that same end, the top portion of each shank 14 can be manipulated to affect the angle at which they are driven into a desired surface. This portion of each shank 14 can be thickened or thinned to affect the driving angle. The composition of the material along this portion of each shank 14 can also be varied in order to affect varying driving angles.

To help prevent the surface that multiple shank nail 10 is being driven into from being splintered or split, each shank 14 is provided with a channel 18. Each channel 18 runs the entire length of its respective shank 14, including the pointed end 16. Added hold is provided for the multiple shank nail 10 after it has been secured into a desired surface with the use of barbs 20. Barbs 20 are located along the surface of each shank 14 and are directed toward head 12 such that they do not prevent shank 14 from easily penetrating a desired surface, yet provide resistance from shank 14 being removed from that surface.

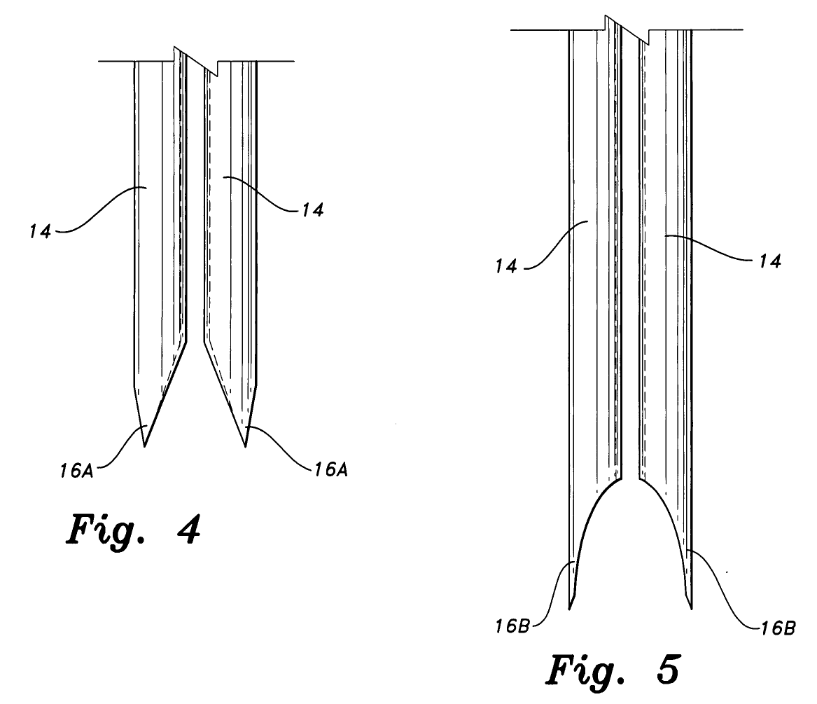

FIGS. 4-5 show a preferred embodiment of shanks 14 with two alternate pointed end configurations. Pointed ends 16A are created with an inside taper and an outside taper such that the distance that shanks 14 are split apart as they are driven into a surface can be minimized. Pointed ends 16B are created with a single curved inside taper to help prevent pointed ends 16B from turning up as shanks 14 are driven into a surface.

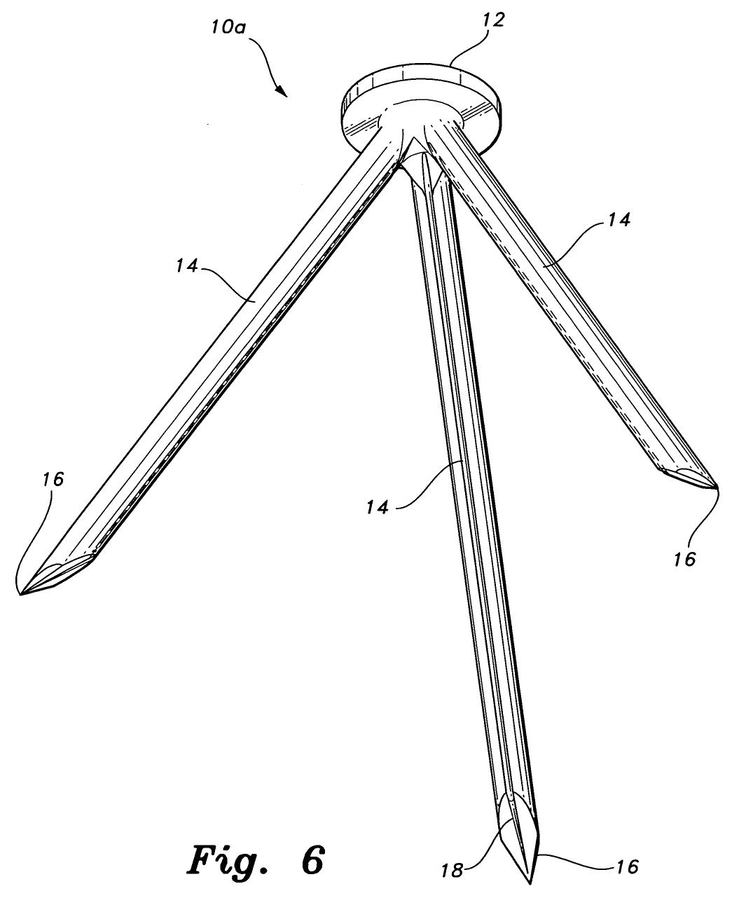

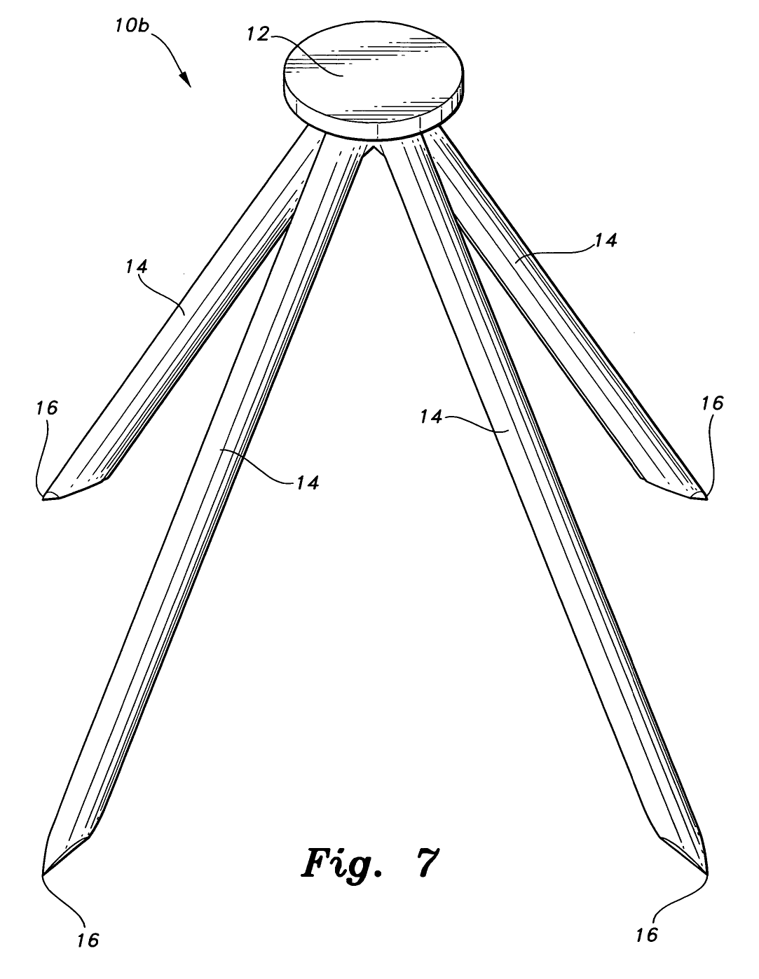

FIGS. 6-7 show alternate embodiments of multiple shank nail 10a, 10b. Multiple shank nail 10a is provided with a head 12 and three shanks 14, each shank extending longitudinally from the bottom surface of head 12 and terminating in pointed end 16. Multiple shank nail 10b is provided with a head 12 and four shanks 14, each shank extending longitudinally from the bottom surface of head 12 and terminating in pointed end 16. In both alternate embodiments, each pointed end 16 of each shank 14 has a tapered configuration such that shanks 14 are split apart as they are driven into a surface by the head 12. The taper of each pointed end 16 can be manipulated such that shanks 14 will be split at varying angles as they are driven into a desired surface.

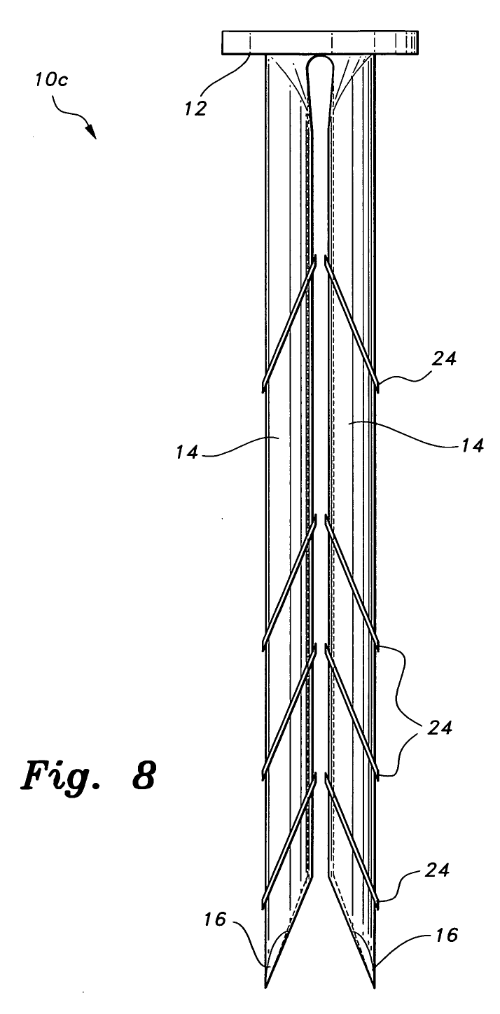

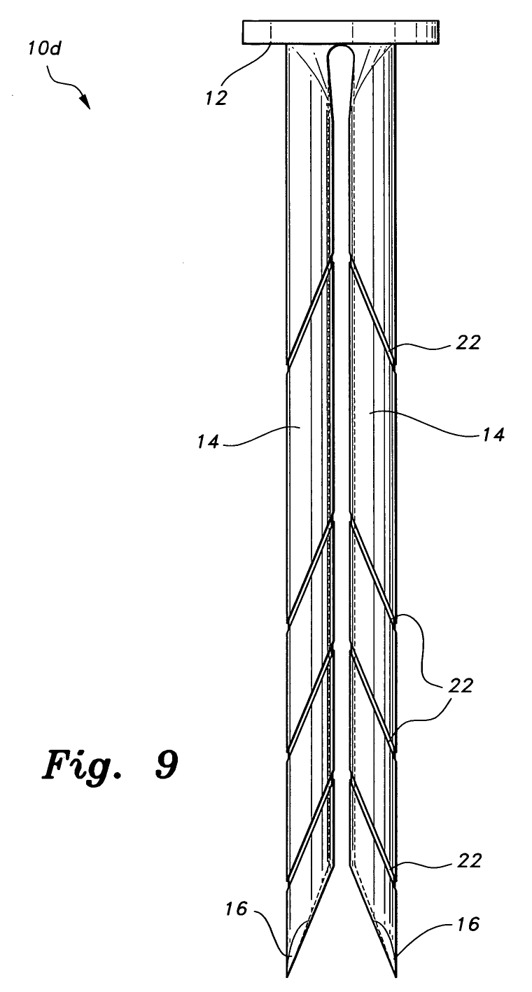

FIGS. 8-9 show additional alternate embodiments of multiple shank nail 10c, 10d. Multiple shank nail 10c is provided with a head 12 and two shanks 14, each shank extending longitudinally from the bottom surface of head 12 and terminating in pointed end 16. Each shank 14 is provided with one or more threads 24. Threads 24 are provided to assist in directing the angle of shanks 14 into the desired surface. Threads 24 can be manipulated in quantity, angle, and circumference in order to affect the driving angle. Threads 24 will also act to provide extra hold for multiple shank nail 10c after it has been driven into the desired surface. Multiple shank nail 10d is provided with a head 12 and two shanks 14, each shank extending longitudinally from the bottom surface of head 12 and terminating in pointed end 16. Each shank 14 is provided with one or more encircling grooves 22. Grooves 22 are provided to assist in directing the angle of shanks 14 into the desired surface. Grooves 22 can be manipulated in quantity, angle, and circumference in order to affect the driving angle. Grooves 22 will also act to provide extra hold for multiple shank nail 10d after it has been driven into the desired surface.

It is to be understood that the present invention is not limited to the embodiments described above, but encompasses any and all embodiments within the scope of the following claims.

I claim:

1. A multiple shank nail, comprising:
a head having a top and bottom surface; and
two or more shanks, each shank extending longitudinally from the bottom surface of the head and terminating in a pointed end.

2. The multiple shank nail according to claim 1, wherein the multiple shank nail has two shanks, the two shanks being separated by a slot extending from a solid portion along the bottom surface of the head through the pointed end of each of the two shanks.

3. The multiple shank nail according to claim 2, wherein each shank is provided with a channel along a surface therein, each channel extending along the entire length of the shank.

4. The multiple shank nail according to claim 3, wherein each shank is provided with a plurality of upwardly extending barbs.

5. The multiple shank nail according to claim 3, wherein each shank is provided with one or more threads.

6. The multiple shank nail according to claim 3, wherein each shank is provided with one or more grooves.

7. The multiple shank nail according to claim 1, wherein the multiple shank nail has three shanks, the three shanks being separated by a series of slots extending from a solid portion along the bottom surface of the head through the pointed end of each of the three shanks.

8. The multiple shank nail according to claim 7, wherein each shank is provided with a channel along a surface therein, each channel extending along the entire length of the shank.

9. The multiple shank nail according to claim 1, wherein the multiple shank nail has four shanks, the four shanks being separated by a series of slots extending from a solid portion along the bottom surface of the head through the pointed end of each of the four shanks.

10. The multiple shank nail according to claim 9, wherein each shank is provided with a channel along a surface therein, each channel extending along the entire length of the shank.

11. A multiple shank nail, comprising:
a head having a top and bottom surface; and
a pair of shanks, each shank extending longitudinally from the bottom surface of the head and terminating in a pointed end, the pair of shanks being separated by a slot extending from a solid portion along the bottom surface of the head through the pointed end of each of the shanks.

12. The multiple shank nail according to claim 11, wherein each shank is provided with a channel along a surface therein, each channel extending along the entire length of the shank.

13. The multiple shank nail according to claim 12, wherein each shank is provided with a plurality of upwardly extending barbs.

14. The multiple shank nail according to claim 12, wherein each shank is provided with one or more threads.

15. The multiple shank nail according to claim 12, wherein each shank is provided with one or more grooves.

16. A multiple shank nail, comprising:
a head having a top and bottom surface; and
a pair of shanks, each shank extending longitudinally from the bottom surface of the head and terminating in a pointed end, the pair of shanks being separated by a slot extending from a solid portion along the bottom surface of the head through the pointed end of each of the shanks, wherein each shank is provided with a channel along a surface therein, each channel extending along the entire length of the shank.

17. The multiple shank nail according to claim 16, wherein each shank is provided with a plurality of upwardly extending barbs.

18. The multiple shank nail according to claim 16, wherein each shank is provided with one or more threads.

19. The multiple shank nail according to claim 16, wherein each shank is provided with one or more grooves.
